(19) United States
(12) Patent Application Publication
(10) Pub. No.: US 2026/0020514 A1
(43) Pub. Date: Jan. 22, 2026

(54) SYSTEMS AND METHODS FOR ENTERIC CARBON DIOXIDE AND METHANE MITIGATION IN RUMINANTS

(71) Applicant: Smart Sprouts International LLC, Carpenter, WY (US)

(72) Inventor: Shawn D. Jenkins, Cheyenne, WY (US)

(73) Assignee: Smart Sprouts International LLC, Carpenter, WY (US)

(21) Appl. No.: 18/775,744

(22) Filed: Jul. 17, 2024

(51) Int. Cl. A01C 1/00; A01G 31/02; A23K 10/30; A23K 40/00; A23K 50/10; A23N 17/00

(52) U.S. Cl. CPC A01C 1/00; A23K 10/30; A23K 40/00; A23K 50/10; A23N 17/001; A01G 31/02

(57) ABSTRACT

The present disclosure relates in general to the imbibition of grains for the ruminant meat production and dairy production industries. More specifically, the present disclosure relates to systems and methods for maximizing the value of sprouted grains as a feedstuff for ruminant livestock using the combined applications of low volts of direct current and negative pressure during grain imbibition. The application of less than or equal to approximately 36.0 volts of direct current to grains in aqueous solutions for at least approximately 120 minutes, in addition to the application of negative pressure of approximately 10.0 inches of mercury (Hg) for at least approximately 60 minutes, have been found to mitigate harmful enteric carbon dioxide (CO₂) and methane (CH₄) emissions to offer opportunities for offset or inset carbon credit generation.

### FIELD OF THE INVENTION

The present disclosure relates in general to the development of sustainable, innovative, and economically viable feedstuffs for ruminant livestock, such as cattle, sheep, and goats. More particularly, but not exclusively, the present disclosure relates to systems and methods for maximizing the value of sprouted grains as a feedstuff for ruminant livestock while reducing associated greenhouse gas emissions to offer opportunities for offset or inset carbon credit generation.

### BACKGROUND

The availability of economically viable and sustainable livestock feed is the largest threat to the future of ruminant meat and dairy production. A recent global food security meta-analysis projected that by the year 2050, overall global food demand will increase from year 2010 levels by over fifty percent, comprising an estimated eighty-eight percent increase in demand for ruminant meat products and a sixty-eight percent increase in demand for ruminant dairy products. See Searchinger et al., Creating A Sustainable Food Future, A Menu of Solutions to Feed Nearly 10 Billion People by 2050, WORLD RESOURCES INSTITUTE (December 2018). As a limiting factor, these large increases in demand must be accomplished with a projected decrease of eight mega hectares (“Mha”) in available crop land and a staggering fifty-two Mha decrease in available global pastureland. Id. Such limitations will thus require an estimated ninety percent increase in the efficiency of ruminant meat production and an estimated seventy percent increase in the efficiency of dairy production from year 2010 levels. Id.

The momentous task of meeting global ruminant livestock demands by the year 2050 are further complicated by elevated greenhouse gas emissions that such large productivity gains are expected to generate. For example, conservative projections estimate an increase of annual emissions from agricultural production processes from 6,769 gigatons of carbon dioxide equivalent (CO₂e) greenhouse gas in the year 2010 to 9,024 gigatons of CO₂e by the year 2050, an increase of approximately fourteen percent. Most of these CO₂e greenhouse gas emissions take the form of carbon dioxide (CO₂) and methane (CH₄), which have powerful warming effects on the environment. Notably, ruminant livestock such as cattle, sheep, and goats, generate approximately fifty percent of all agricultural production emissions. Of these emissions, the largest source is “enteric methane,” generated by microbes in the stomachs of ruminant livestock. Id.

Thus a desire remains to develop systems and methods that mitigate harmful enteric carbon dioxide (CO₂) and methane (CH₄) emissions for the ruminant meat production and dairy production industries. A desire further remains to develop systems and methods that increase the availability of economically viable and sustainable livestock feed for the ruminant meat production and dairy production industries. A desire still further remains to develop systems and methods that maximize the efficiency at which livestock feed is transformed into marketable protein for the ruminant meat production and dairy production industries.

### SUMMARY

In one aspect of the present disclosure, a method for maximizing the value of grains as a feedstuff for livestock is provided. The method may include forming an aqueous solution comprising water. The method may further include contacting the grains with the solution, applying low volts of direct current to the grains and the solution for a first period of time, and reducing the pressure over the grains and the solution for a second period of time.

In another aspect of the present disclosure, a method for maximizing the value of grains as a feedstuff for livestock is provided. The method may include providing a system for imbibing grains. The method may further include introducing the grains to an aqueous solution comprising water and at least one plant additive, an optional reactive oxygen species, and at least one metallic salt. The grains in solution may be placed into an electrode chamber and a vacuum chamber. Low volts of direct current may be applied to the grains and the solution comprising less than or equal to approximately 36.0 volts of direct current, wherein the low volts of direct current may be maintained for a first chosen time period of at least approximately 120 minutes. The pressure may be reduced over the grains and the solution to approximately 10.0-25.0 inches of mercury (Hg), wherein the reduced pressure may be maintained for approximately 60-240 minutes. After imbibition, the grains may be removed from the solution, the electrode chamber, and the vacuum chamber and introduced into a growing station where they are developed into plant seedlings and ultimately harvested and processed for their intended use in, e.g., the ruminant meat production and dairy production industries.

In another aspect of the present disclosure, a system for maximizing the value of grains as a feedstuff for livestock is provided. The system may include a plurality of grains to be imbibed, an aqueous solution for imbibing the grains containing at least one plant additive and at least one metallic salt in water, an electrode chamber configured to apply low volts of direct current to the grains in the solution, a vacuum chamber configured to apply negative pressure to the grains in the solution, and a growing station for cultivating imbibed grains into plant seedlings.

### OBJECTS, FEATURES, AND ADVANTAGES

It is a principal object, feature, and advantage of the present disclosure to overcome the aforementioned deficiencies in the art and provide systems and methods that mitigate harmful enteric carbon dioxide (CO₂) and methane (CH₄) emissions for the ruminant meat production and dairy production industries.

Another object, feature, and advantage of the present disclosure is to provide systems and methods that increase the availability of economically viable and sustainable livestock feed for the ruminant meat production and dairy production industries.

Yet another object, feature, and advantage of the present disclosure is to provide systems and methods that maximize the efficiency at which livestock feed is transformed into marketable protein for the ruminant meat production and dairy production industries.

A further object, feature, and advantage of the present disclosure is to provide systems and methods that cost effectively increase the supply of soluble sugars for inclusion in ruminant diets to reduce enteric carbon dioxide (CO₂) and methane (CH₄) emissions for the ruminant meat production and dairy production industries.

A still further object, feature, and advantage of the present disclosure is to provide systems and methods that increase the concentration of soluble sugars in ruminant diets by approximately 8-24% as compared to traditional livestock feeds.

A further object, feature, and advantage of the present disclosure is to provide systems and methods that reduce greenhouse gas emissions while offering opportunities for offset or inset carbon credit generation.

Other objects, features, or advantages of this disclosure will become apparent from the following detailed description and claims, taken in conjunction with the accompanying drawings that set forth, by way of illustration and example and without limitation, certain aspects of this disclosure. No single aspect need provide each and every object, feature, or advantage. Thus the present disclosure is not to be limited to or by these objects, features, and advantages.

### BRIEF DESCRIPTION OF THE DRAWINGS

The accompanying drawings, incorporated herein and forming a part of the specification, illustrate aspects of the present disclosure together with the detailed description and claims.

FIG. 1 is a diagram illustrating a system of maximizing the value of sprouted grains as a feedstuff for ruminant livestock while reducing associated greenhouse gas emissions, according to the present disclosure.

FIG. 2 is a flowchart illustrating a method of maximizing the value of sprouted grains as a feedstuff for ruminant livestock while reducing associated greenhouse gas emissions, according to the present disclosure.

FIG. 3 is a graph showing the influence of experimental diets comprising sprouted cereal grains grown according to the systems and methods of the present disclosure on percentage dry matter (DM), crude protein (CP), starch, acid detergent fiber (ADF), neutral detergent fiber (aNDF), sugar (WSC), non-fiber carbohydrates (NFC), energy density expressed as net energy of gain (Neg), and diet cost.

FIG. 4 is a graph showing the influence of experimental diets comprising sprouted cereal grains grown according to the systems and methods of the present disclosure on crude protein (CP), starch, total tract starch (TTSD), fiber (aNDF) and fat digestion.

FIG. 5 is a graph showing the influence of experimental diets comprising sprouted cereal grains grown according to the systems and methods of the present disclosure on dry matter feed intake (DMI), water intake, total water intake (including moisture consumed in feed), average daily weight gain (ADG), feed to body weight conversion ratio (FCR), daily feed cost, and daily income generated over feed cost (IOFC).

FIG. 6 is a graph showing the influence of experimental diets comprising sprouted cereal grains grown according to the systems and methods of the present disclosure on average daily weight gain (ADG), enteric methane emission (CH₄), enteric carbon dioxide emission (CO₂), the ratio of enteric carbon dioxide to enteric methane emission (CO₂/CH₄), enteric greenhouse gas emission expressed as carbon dioxide equivalents (CO₂e), and the intensity of previously mentioned gasses on a intensity or per daily weight gain basis.

FIG. 7 is a graph showing the influence of experimental diets comprising sprouted cereal grains grown according to the systems and methods of the present disclosure on the nutrient profile of corn as compared to traditional livestock feeds.

FIG. 8 is a graph showing the influence of experimental diets comprising sprouted cereal grains grown according to the systems and methods of the present disclosure on in situ organic matter digestibility (OMD) as influenced by incubation period. Timepoint estimates and 95% confidence intervals are illustrated.

FIG. 9 is a graph showing the influence of experimental diets comprising sprouted cereal grains grown according to the systems and methods of the present disclosure on in situ starch digestibility (iSSD) as influenced by incubation period. Timepoint estimates and 95% confidence intervals are illustrated. processing.

FIG. 10 is a graph showing the influence of experimental diets comprising sprouted cereal grains grown according to the systems and methods of the present disclosure on in situ percentage rumen undigested protein (RUP) as influenced by incubation period. Timepoint estimates and 95% confidence intervals are illustrated.

### DETAILED DESCRIPTION

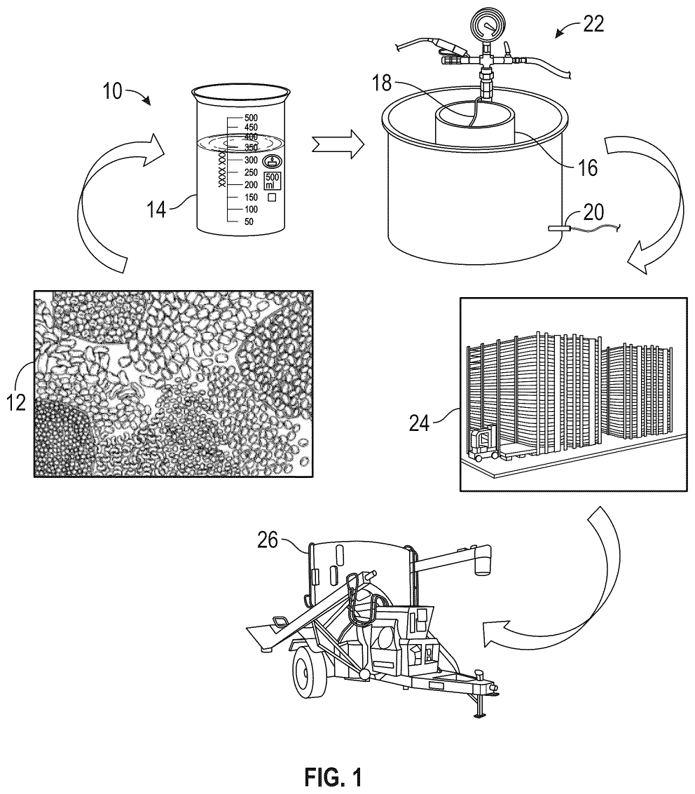

Referring generally to FIGS. 1-10, the present disclosure relates to systems and methods of maximizing the value of sprouted grains as a feedstuff for ruminant livestock, including hindgut fermenters, while reducing associated greenhouse gas emissions. While primarily directed towards the ruminant meat production and dairy production industries, it is contemplated by the present disclosure that such systems and methods may be also applied to the agronomic, horticulture, animal feed, and malting industries. Benefits of maximizing the value of sprouted grains as a feedstuff for ruminant livestock include, but are not limited to, the ability to mitigate harmful enteric carbon dioxide (CO₂) and methane (CH₄) emissions to offer opportunities for offset or inset carbon credit generation. The availability of economically viable and sustainable livestock feed is also increased when using the systems and methods of the present disclosure for commercial applications. Moreover, additional benefits of utilizing the systems and methods of the present disclosure include the ability to maximize the efficiency at which livestock feed is transformed into marketable protein for the ruminant meat production and dairy production industries.

Grains contemplated to be utilized with the systems and methods of the present disclosure may include any vascular seed plant, and particularly angiosperms, which possess the specialized endosperm food supply inside the seed coat. Endosperm is the chief storage tissue in the seeds of cereal grains and grain legumes, which are both utilized as major food sources by humans and animals. Cereal grains may include, but are not limited to, wheat (Triticum aestivum), corn (Zea mays), rice (Oryza sativa), wild rice (Zizania palustris), barley (Hordeum vulgare), oats (Avena sativa), rye (Secale cereale), sorghum (Sorghum bicolor), bulgur, teff Eragrostis tef), triticale (Triticosecale), and millet (Panicum millaceum). Other grains may include, but are not limited to, Amaranth, buckwheat (Fagopyrum esculentum), and quinoa (Chenopodium quinoa Willd.). Grain legumes, also known as pulses, may include, but are not limited to, soybean (Glycine max), lentil (Lens esculenta), peas (Pisum sativum), chick pea (Cicer arietinum), faba bean (Vicia faba), cowpea (Vigna sinensis), pigeonpea (Cajanas cajan, Cajanus indicus), and peanut (Arachis hypogaea).

While certain aspects of the present disclosure are shown and described herein, it is understood that such aspects are merely exemplary. The present disclosure is not intended to be limited to these specific aspects and may encompass other aspects or embodiments. Therefore, specific system and method details disclosed herein are not to be interpreted or inferred as limiting, but merely as a basis for the claims and as a representative basis for teaching one skilled in the art how to make and use the disclosed subject matter.

It must further be noted that the singular terms “a,” “an,” and “the” as used herein may include plural referents unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

All words of approximation as used in the present disclosure and claims should be construed to mean “approximate,” rather than “perfect” or “exact,” and may be used as a modifier to any other word, number, quantity, quality, value, or specified parameter. Words of approximation, include, but are not limited to terms such as “about,” “approximately,” “around,” “almost,” “generally,” “largely,” “essentially,” “substantially,” etc. As used herein, in some aspects, the terms “about” or “approximately” when preceding a numerical value may indicate the value plus or minus a range of 0.1, 0.2, 0.3, 0.4 or 0.5 inch of mercury (Hg). In other aspects, the terms “about” or “approximately” when preceding a numerical value may indicate the value plus or minus a range of 1, 2, 3, 4 or 5 inches of mercury (Hg). In further aspects, the terms “about” or “approximately” when preceding a numerical value may indicate the value plus or minus a range of 1, 2, 3, 4, or 5 volts of direct current. In still further aspects, the terms “about” or “approximately” when preceding a numerical value may indicate the value plus or minus a range of 1, 2, 3, 4, or 5 volts per centimeter of electric field (V/cm). In some aspects, the terms “about” or “approximately” when preceding a numerical value may indicate the value plus or minus a range of 1, 2, 3, 4, or 5 mm. In other aspects, the terms “about” or “approximately” when preceding a numerical value may indicate the value plus or minus a range of 0.1, 0.2, 0.3, 0.4, or 0.5 ppm. In further aspects, the terms “about” or “approximately” when preceding a numerical value may indicate the value plus or minus a range of 1, 2, 3, 4, or 5 ppm. In still further aspects, the terms “about” or “approximately” when preceding a numerical value may indicate the value plus or minus a range of 0.1, 0.2, 0.3, 0.4, or 0.5 ml. In some aspects, the terms “about” or “approximately” when preceding a numerical value indicates the value plus or minus a range of 1, 2, 3, 4, or 5 ml. In other aspects, the terms “about” or “approximately” when preceding a numerical value indicates the value plus or minus a range of 1, 2, 3, 4, or 5 seconds. In further aspects, the terms “about” or “approximately” when preceding a numerical value indicates the value plus or minus a range of 1, 2, 3, 4, or 5 minutes. In still further aspects, the terms “about” or “approximately” when preceding a numerical value indicates the value plus or minus a range of 1, 2, 3, 4, or 5° Celsius. In some aspects, the terms “about” or “approximately” when preceding a numerical value indicates the value plus or minus a range of 1, 2, 3, 4, or 5 feet.

Furthermore the transitional phrase “comprising” that is synonymous with “including,” “containing,” and “characterized by” as used herein is inclusive or open-ended and does not exclude additional, unrecited elements, steps or ingredients. Alternatively the transitional phrase “consisting of” as used herein is closed and excludes any element, step or ingredient not specified. The transitional phrase “consisting essentially of” limits the scope of a claim to the specified materials or steps and those that do not materially affect the basic and novel characteristics of the claims.

For purposes of the present disclosure, the terms “negative pressure,” “reduced pressure,” and “vacuum pressure” are used interchangeably and defined herein as “pressure that is less than standard atmospheric pressure.” The term “positive pressure” is defined herein as “pressure that is greater than standard atmospheric pressure.” The term “standard atmospheric pressure” is defined herein as “29.92 inches of mercury (Hg).” The terms “low voltage,” “low volts of direct current,” “low voltage direct current,” and “low VDC” are used interchangeably and defined herein as “approximately less than or equal to 36.0 volts direct current.” The terms “high voltage,” “high volts of direct current,” “high voltage direct current,” and “high VDC” are used interchangeably and defined herein as “approximately greater than or equal to 1.0 kilovolts direct current.” The terms “high voltage electric field” and “HVEF” are used interchangeably and defined herein as “approximately greater than or equal to 3.0 kilovolt/cm.”

FIG. 1 illustrates one aspect of the present disclosure, in particular, a system (10) of maximizing the value of sprouted grains as a feedstuff for ruminant livestock while reducing associated greenhouse gas emissions. The system (10) may comprise a plurality of grains (12) to be imbibed, including at least one of cereal grains, grain legumes, and other grains for animal or human consumption. The grains (12) may be intended for use in commercial applications such as, but not limited to, the following industries:
Applications in the ruminant meat production industry to enable producers, processors, and retailers to produce low-carbon meat products that generate inset carbon credits.
Applications in the ruminant dairy production industry to enable producers, processors, and retailers to produce low-carbon dairy products that generate inset carbon credits.

Shown in FIG. 1, the system (10) may further comprise an aqueous solution (14) for imbibing the grains (12). The solution (14) may comprise a sufficient amount of water (H₂O) for submerging the grains (12). As a non-limiting example, the water (H₂O) may be approximately 2,000 ml of sterilized distilled water (H₂O). It is also contemplated by the present disclosure that greater amounts of water (H₂O) may be utilized for large-scale, commercial operations.

The solution (14) may comprise approximately 3.0-10.0 ppm of plant additives. Plant additives contemplated to be imbibed into grains using the systems and methods of the present disclosure include, but are not limited to, nutrients, fungicides, insecticides, signaling compounds, and exogenous phytohormones. Exemplary exogenous phytohormones of the present disclosure include, but are not limited to, cytokinins for promoting cell division (e.g., synthetic cytokinin thidiazuron), auxins for promoting plant growth (e.g., synthetic auxin 1-Naphthaleneacetamide), and gibberellins for controlling seed germination (e.g., gibberellic acid (GA₃)). As a non-limiting example, the solution (14) may comprise approximately 3.0-10.0 ppm of GA₃. In other examples, the solution (14) may comprise approximately 0.75-10.0 ppm of GA₃, approximately 1.0-2.0 ppm of 1-Naphthaleneacetamide, and approximately 1.0-5.0 ppm of thidiazuron.

In some aspects, the solution (14) may optionally comprise approximately 40.0-60.0 ppm of a reactive oxygen species (ROS). ROS are a class of highly reactive and oxygen-bearing molecules that include superoxide anion (O₂⁻), hydrogen peroxide (H₂O₂), hydroxyl radical (OH), and singlet oxygen (102). It is well known that ROS plays an important role in the regulation of seed dormancy, germination, and deterioration. See Kurek et al., Reactive Oxygen Species as Potential Drivers of the Seed Aging Process, PLANTS, Vol. 8, Iss. 6, p. 174 (Jun. 14, 2019); see also Considine et al., Oxygen and reactive oxygen species-dependent regulation of plant growth and development, PLANT PHYSIOLOGY, Vol. 186, Iss. 1, pp. 79-92 (May 27, 2021). In particular, ROS may interact with the hard outer layer of the seed coat causing it to weaken and permit water to enter quickly to initiate germination. It is also well known that ROS may be used as a weapon against pathogens on the seed coat, being either directly toxic against pathogenic microorganisms or trigger hypersensitive reaction and programmed cell death at sites attacked by pathogens. See Lamb et al., The Oxidative Burst In Plant Disease Resistance, ANNUAL REVIEW OF PLANT BIOLOGY, Vol. 48, pp. 251-274 (June 1997). Therefore, utilizing ROS in the solution (14) will likely constitute a defense reaction for the grains (12) against infection by harmful microorganisms.

The solution (14) may comprise at least approximately 75.0 ppm of metallic salts. Metallic salts contemplated by the present disclosure include, but are not limited to, magnesium sulfate (MgSO₄), potassium nitrate (KNO₃), sodium chloride (NaCl), or combinations thereof. In some aspects, the metallic salts may comprise magnesium sulfate (MgSO₄) at approximately 75.0-85.0 ppm, potassium nitrate (KNO₃) at approximately 140.0-160.0 ppm, sodium chloride (NaCl) at approximately 75.0-85.0 ppm, or combinations thereof. In other aspects, the metallic salts may comprise magnesium sulfate (MgSO₄) at approximately 75.0 ppm and potassium nitrate (KNO₃) at approximately 150.0 ppm. In further aspects, the metallic salts may comprise magnesium sulfate (MgSO₄) at approximately 75.0 ppm. In still further aspects, the metallic salts may comprise potassium nitrate (KNO₃) at approximately 150.0 ppm. In other aspects, the metallic salts may comprise sodium chloride (NaCl) at approximately 75.0 ppm. The introduction of metallic salts into the solution (14) may increase the effectiveness of the low voltage treatment in stimulating a positive effect on seed germination and plant seeding development. Metallic salts, when dissolved in water, dissociate into charged ions that become mobile and can conduct electricity. The presence of mobile ions in the water increases the overall conductivity of the water and allows the electric current to flow more easily through the solution (14) and through the grains (12). In addition to increased conductivity, the uniformity of the electric field is improved with increased conductivity thereby increasing the effective range of the electric application. Uniformity of the low voltage electric field is one of the biggest obstacles when applying low voltage direct current to an aqueous solution, and the inclusion of metallic salts appears to help overcome this obstacle.

Further shown in FIG. 1, the system (10) may comprise an electrode chamber (16) for applying low voltage to the grains (12) in the solution (14) for a set imbibition duration time. As a non-limiting example, the electrode chamber (16) may include a 5.7 L container formed from high quality, durable insulating materials such as polyethylene or polypropylene for holding the grains (12) in the solution (14). The electrode chamber (16) may further comprise at least one positively charged electrode (18), or anode, and at least one negatively charged electrode (20), or cathode. The positively charged electrode (18) may be introduced into the solution (14) and connected to an external power supply (not shown) designed to apply low voltage to the system (10). The negatively charged electrode (20) may be connected to a grounding source, such as but not limited to, the container of the electrode chamber (16) holding the grains (12) in solution (14) and/or a vessel of a vacuum chamber (22). Direction of polarity in the system (10) is important to achieve maximum positive effects on seed germination and plant seedling development. In particular, the positively charged electrode (18) should be introduced into the solution (14) and the negatively charged electrode (20) should be connected to the grounding source, such as but not limited to, the container of the electrode chamber (16). If the direction of polarity is reversed, limited positive effects to seed germination and plant seedling development are achieved. It is also contemplated by the present disclosure that alternative electrode chambers (16) and power supplies of different sizes and strengths may also be utilized in the system (10) depending on the amount of grains (12) needed to be imbibed, such as for large scale industrial applications.

Still further shown in FIG. 1, the system (10) may comprise a vacuum chamber (22) for applying negative pressure to the grains (12) in the solution (14) for a set imbibition duration time. The vacuum chamber (22) may comprise a rigid enclosure from which air and other gases are removed by a vacuum pump. The vacuum chamber (22) is configured to create a low-pressure environment inside its chamber, commonly referred to as a vacuum. The vacuum chamber (22) may be comprised of stainless steel, aluminum, other metals, or rigid plastics. As a non-limiting example, the vacuum chamber (22) may include a 5.7-19 L enclosure connected to a 3.6 cubic feet/minute (CFM) single-stage vacuum pump. It is contemplated by the present disclosure that other vacuum chambers (22) of different sizes and strengths may also be utilized in the system (10) depending on the amount of grains (12) needed to be imbibed, such as for large scale operations depending on the industry. It is further contemplated by the present disclosure that the vacuum chamber (22) and the electrode chamber (16) may be combined into a single apparatus capable of performing both functionalities.

Also shown in FIG. 1, the system (10) may comprise a growing station (24) for cultivating the imbibed grains into plant seedlings. In some aspects, the growing station (24) may comprise soil cultivation such as in large scale outdoor agricultural production operations that involve extensive land, machinery, and labor resources to produce crops or raise livestock. In other aspects, the growing station (24) may comprise indoor and/or outdoor stations where grains are grown hydroponically or acroponically using natural light, artificial light, or combinations thereof. While both hydroponics and acroponics cultivate plants without soil, the techniques are distinct. In hydroponics plants are typically submerged in water that has been enriched with nutrients. Conversely in acroponics, the roots of plants are suspended in the air and misted with water that has been enriched with nutrients. When compared to soil-cultivated plants, hydroponic and acroponic growing stations provide improved growth, yield, quality, and production to the plant seedling. Acroponics provide even greater benefits when compared to hydroponics, where plants grown acroponically have 100% access to CO₂ for photosynthesis and consume 70% less water than hydroponics. See Kumar et al., Vertical farming and organic farming integration: a review, ORGANIC FARMING, 2^{ND} ED., pp. 291-315 (2023). Thus, in preferred aspects of the present disclosure the growing station (24) comprises aeroponics.

As a non-limiting example, the growing station (24) of the present disclosure may comprise a vertical series of platforms forming a tower structure. Each platform of the series may comprise a plurality of seed trays for housing the grains (12), wherein each seed tray may be approximately 8-12 feet in width and 10-14 feet in length. As a non-limiting example, the seed trays may comprise a custom rotomolded tray configured to be transportable, e.g., by a forklift. Each seed tray may be configured to house grains (12) placed therein at approximately 1-3 inches in thickness. Each platform of the tower may comprise a series of misting nozzles located above the seed trays, the misting nozzles designed to mist the grains (12) at set intervals with water that has been enriched with nutrients for optimal germination, uniformity, and growth of the plant seedlings. The growing station (24) may be a closed loop system that includes at least one storage tank used to store nutrient-rich water for application to the grains, in addition to conserving excess water after grain application, wherein the excess water may be later reapplied to the grains to reduce water consumption and improve efficiency of the growing station (24). The growing station (24) may be housed indoors or outdoors and use natural light, artificial light, or combinations thereof to initiate germination and encourage rapid growth of the plant seedlings for improved yields and performance. Once the plant seedling reaches a preferred stage of growth, the seed trays housing the grains may be removed from their respective platforms on the tower structure and the plant seedlings harvested for their intended use in the ruminant meat production and dairy production industries.

In some instances, the growing station (24) may comprise positive-pressure precision ventilation systems wherein ventilation, irrigation, lighting, temperature, and humidity control may be automatically adjusted and controlled by a variety of sensors and software systems. As non-limiting examples, the variety of sensors may comprise temperature, electrical conductivity, and moisture sensors that may be placed in all of or a subset of the growing trays to continually measure and monitor developmental status of the grains. Lighting may also be artificially suppled that provides an increased red light to far red light (R:FR) ratio. An increased R:FR ratio may positively impact the phytochrome I receptor of plant seedlings to increase endogenous gibberellic acid (GA₃) release for improved development. The production cycle may also be particularly timed to maximize glucose production per square foot to increase the supply of reduced sugars to ruminants for improved efficiency. The growing station (24) may further comprise a mechanical processor (26), such as but not limited to, a portable or stationary grinder/mixer for chopping the harvested plant seedlings. Mechanical processing of the harvested plant seedlings is designed to minimize product size and maximize enzymatic activity in the diet (i.e., total mixed ration) for the ruminant livestock. In particular, by rupturing the pericarp, hydrolytic enzymes produced in the harvested plant seedlings may encounter out feedstuffs prior to livestock consumption for the ruminant meat and dairy production industries.

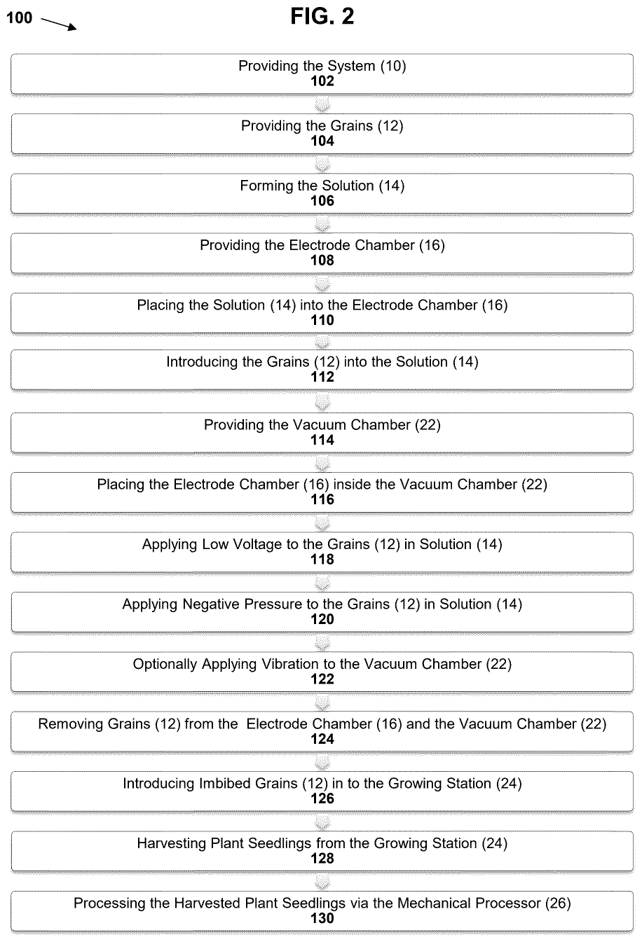

FIG. 2 illustrates another aspect of the present disclosure, in particular, a method (100) of maximizing the value of sprouted grains as a feedstuff for ruminant livestock while reducing associated greenhouse gas emissions. The method (100) may comprise providing (102) the system (10) of FIG. 1, along with providing (104) the grains (12) for imbibition. The method (100) may further comprise forming (106) the aqueous solution (14). The solution (14) may be formed by providing a sufficient amount of water (H₂O) to submerge the grains (12). As a non-limiting example, the water (H₂O) may be approximately 2,000 ml of sterilized distilled water (H₂O). It is contemplated by the present disclosure that greater amounts of water (H₂O) may be utilized for large-scale, commercial operations.

The method (100) may comprise introducing approximately 3.0-10.0 ppm of plant additives into the sterilized distilled water (H₂O) to form the solution (14). As a non-limiting example, the plant additives may comprise at least one of the exogenous phytohormones cytokinin thidiazuron, auxin 1-Naphthaleneacetamide, and gibberellic acid (GA₃). In some aspects, the solution (14) may comprise approximately 3.0-10.0 ppm of GA₃. In other aspects, the solution (14) may comprise approximately 0.75-10.0 ppm of GA₃, approximately 1.0-2.0 ppm of 1-Naphthaleneacetamide, and approximately 1.0-5.0 ppm of thidiazuron.

In some instances, the method (100) may optionally comprise introducing approximately 40.0-60.0 ppm of an ROS into the sterilized distilled water (H₂O) to form the solution (14). As a non-limiting example, the ROS may comprise hydrogen peroxide (H₂O₂).

The method (100) may comprise introducing at least approximately 75.0 ppm of metallic salts into the sterilized distilled water (H₂O) to form the solution (14). Metallic salts contemplated by the present disclosure include, but are not limited to, magnesium sulfate (MgSO₄), potassium nitrate (KNO₃), sodium chloride (NaCl), or combinations thereof. In some aspects, the metallic salts may comprise magnesium sulfate (MgSO₄) at approximately 75.0-85.0 ppm, potassium nitrate (KNO₃) at approximately 140.0-160.0 ppm, sodium chloride (NaCl) at approximately 75.0-85.0 ppm, or combinations thereof. In other aspects, the metallic salts may comprise magnesium sulfate (MgSO₄) at approximately 75.0 ppm and potassium nitrate (KNO₃) at approximately 150.0 ppm. In further aspects, the metallic salts may comprise magnesium sulfate (MgSO₄) at approximately 75.0 ppm. In still further aspects, the metallic salts may comprise potassium nitrate (KNO₃) at approximately 150.0 ppm. In other aspects, the metallic salts may comprise sodium chloride (NaCl) at approximately 75.0 ppm.

It is contemplated by the present disclosure that after introducing the plant additives, optional ROS, metallic salts, or combinations thereof into the sterilized distilled water (H₂O), the solution (14) may be mixed to form the solution (14). It is further contemplated by the present disclosure that the mixture of plant additives, optional ROS, metallic salts, or combinations thereof in the sterilized distilled water (H₂O) may comprise a homogeneous mixture or a heterogeneous mixture to form the solution (14). After mixing the plant additives, optional ROS, metallic salts, or combinations thereof in the sterilized distilled water (H₂O), the solution (14) may be chilled to approximately 6°-18° Celsius.

Shown in FIG. 2, the method (100) may comprise providing (108) the electrode chamber (16). The method (100) may further comprise placing (110) the solution (14) into the container of the electrode chamber (16), and thereafter introducing (112) the grains (12) into the solution (14). In particular, the positively charged electrode (18) of the electrode chamber (16) should be introduced into the solution (14) and the negatively charged electrode (20) should be connected to a grounding source, such as but not limited to, the container of the electrode chamber (16). As explained above, direction of polarity in the system (10) is important to achieve maximum positive effects on seed germination and plant seedling development, as reverse polarity fails to achieve similar results. The method (100) may also comprise providing (114) the vacuum chamber (22) and placing (116) the electrode chamber (16) inside the vacuum chamber (22). Alternatively, it is contemplated by the present disclosure that the vacuum chamber (22) and the electrode chamber (16) may be combined into a single apparatus capable of performing both functionalities.

Using the electrode chamber (16), low voltage may be applied (118) to the grains (12) in the solution (14) at a certain VDC and for a set imbibition duration time to stimulate the positive effect on seed germination and plant seeding development. As a non-limiting example, a maximum voltage of approximately 36.0 VDC constantly applied to the grains (12) in the solution (14) for a minimum imbibition duration time of approximately thirty minutes is needed to realize positive effects in seed germination and plant seedling development. In some aspects, low voltage may be constantly applied to the grains (12) in the solution (14) at approximately 8.0-13.0 VDC for a minimum imbibition duration time of approximately 120 minutes. In other aspects, low voltage may be constantly applied to the grains (12) in the solution (14) at approximately 5.0-7.0 VDC for a minimum imbibition duration time of approximately 120 minutes. In further aspects, low voltage may be constantly applied to the grains (12) in the solution (14) at approximately 2.0-4.0 VDC for a minimum imbibition duration time of approximately 120 minutes.

Using the vacuum chamber (22), negative or reduced pressure may be applied (120) to the grains (12) in the solution (14) at a certain pressure and for a set imbibition duration time to promote rapid and uniform rates of imbibition. As a non-limiting example, negative pressure may be applied (116) to the grains (12) in the solution (14) at approximately 10.0-25.0 inches of mercury (Hg) for approximately 60-240 minutes. In some aspects, negative pressure may be constantly applied (116) to the grains (12) in the solution (14) at approximately 10.0 inches of mercury (Hg) for a total imbibition duration time of approximately 180 minutes. In other aspects, negative pressure may be constantly applied (112) to the grains (12) in the solution (14) at approximately 20.0 inches of mercury (Hg) for approximately 180 minutes. In further aspects, negative pressure may be constantly applied (112) to the grains (12) in the solution (14) at approximately 25.0 inches of mercury (Hg) for approximately 180 minutes. In still further aspects, negative pressure may be intermittently applied (116) to the grains (12) in the solution (14) at approximately 10.0 inches of mercury (Hg) for a total imbibition duration time of approximately 180 minutes, wherein the negative pressure may be released for approximately twenty seconds at fifteen minute intervals during the total imbibition duration time. A minimum negative pressure of approximately 10.0 inches of mercury (Hg) applied (116) to the grains (12) in the solution (14) for a minimum imbibition duration time of approximately sixty minutes is needed to realize positive effects in rapid and uniform rates of imbibition.

Further shown in FIG. 2, the method (100) may optionally comprise applying vibration (122) to the vacuum chamber (22) during imbibition of the grain (12) for a set time period and at a chosen vibrational frequency. As a non-limiting example, vibration may be applied to the vacuum chamber (22) during imbibition of the grain (12) for approximately one minute every fifteen minutes of the imbibition duration time. Alternatively, vibration may be constantly applied to the vacuum chamber (22) during the total imbibition duration time. As a further non-limiting example, vibration may be applied to the vacuum chamber (22) during imbibition of the grain (12) at a vibration frequency of approximately thirty-three Hertz (Hz), or about 2,000 revolutions per minute (RPM). Vibration of the vacuum chamber (22) may influence a seed coat's inherent surface tension and slightly hydrophobic nature to promote imbibition. Thus vibration of the vacuum chamber (22) may help to mitigate variations in water and plant additive imbibition rates that may negatively impact germination times and resultant seedling development.

Still further shown in FIG. 2, after low voltage and negative pressure have been applied (118, 120) to the grains (12) in solution (14) for a set imbibition duration time, including the optional vibration application (122), the grains (12) may be removed (124) from the electrode chamber (16) and the vacuum chamber (22) and introduced (126) into the growing station (24). Once the grains germinate and reach a preferred stage of growth in plant seedling development, the plant seedlings may be removed or harvested (128) from the growing station (18). Harvesting the plant seedlings may include mechanical processing (130), such as but not limited to, the application of a portable or stationary grinder/mixer (26) for at least approximately five minutes. The mechanical processing of the plant seedlings is configured to grind, chop, and mix the harvested product to minimize size and maximize enzymatic activity in the diet (i.e., total mixed ration) for intended use as feedstuffs in the ruminant meat and dairy production industries. In this manner, the method (100) of the present disclosure increases the concentration of soluble sugars in ruminant diets by approximately 8-24% as compared to the 4-9% soluble sugar concentrations found in traditional livestock feeds.

It has been theorized that a possible approach to reduce greenhouse gasses associated with ruminant meat and dairy production is to elevate levels of lactic acid producing bacteria within the rumen of ruminant livestock. See, e.g., Doyle et al., Use of Lactic Acid Bacteria to Reduce Methane Production in Ruminants, a Critical Review, FRONTIERS IN MICROBIOLOGY, Vol. 10, Art. 2207 (Oct. 1, 2019). Indeed lactic acid producing bacteria and their metabolites are known to shift rumen fermentation patterns away from methanogenesis to reduce the necessary inputs required for methanogenic archaca to produce methane. Id. Although the theoretical basis for lactic acid producing bacteria to inhibit enteric greenhouse gas production is well understood, the ability to elevate lactic acid producing bacteria economically in a commercial application has yet to be realized. The reason for this lack of realization is because while lactic acid producing bacteria readily proliferate on soluble sugars, however, such bacteria are unable to break down complex polysaccharides commonly associated with forages and grains used in traditional livestock feeds. Sprouted grains thus provide an exceptionally unique substrate favored by lactic acid producing bacteria due to an increased concentration of available soluble sugars that support proliferation. As a result, it is contemplated by the present disclosure that the administration of sprouted grains through the proliferation of lactic acid producing bacteria will reduce enteric carbon dioxide (CO₂) and methane (CH₄) emissions while at the same time improving feed efficiency as compared to traditional livestock feeds. This reduction in enteric carbon dioxide (CO₂) and methane (CH₄) emissions as compared to traditional livestock feeding practices can be measured and utilized to generate carbon reduction credits in the ruminant meat production and dairy production industries, in addition to, but not limiting, the greater agronomic, horticulture, animal feed, and malting industries.

### Grower Experimental Examples

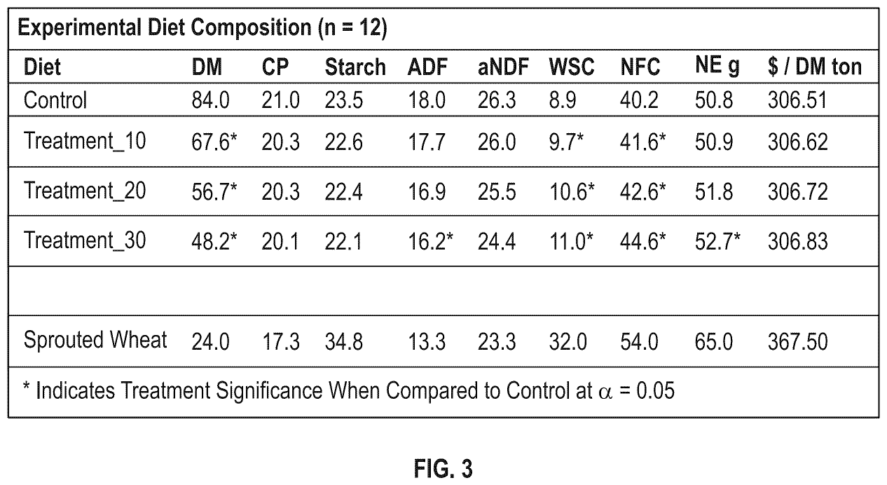

Illustrated in FIGS. 3-10, the following non-limiting examples demonstrate the combined systems and methods for maximizing the value of sprouted grains as a feedstuff for ruminant livestock while reducing associated greenhouse gas emissions. In these examples, individual cattle were penned separately inside a livestock confinement building and fed experimental diets. In particular, four angus steers weighing approximately 740 pounds were randomly assigned to individual pens measuring approximately 100 square feet in a 4×4 Latin square experimental design. Experimental diets were administered to the cattle that comprised 0%, 10%, 20%, and 30% sprouted cereal grains on a dry matter (DM) basis. Experimental diets were held constant for crude protein and energy concentration to avoid confounding nutrient composition effects. Experimental diets were randomly assigned to each pen and administered for a two week period. Four experimental feeding periods were conducted over an eight week period to balance individual cattle treatment effects with experimental diet treatment effects. Daily recordings of cattle included: dry matter intake; water intake; methane (CH₄) eructation concentration; and carbon dioxide (CO₂) eructation concentration. At the end of each experimental feeding period, total mix ration (TMR), manure composition, and rate of gain were measured and evaluated. The average starting weight of the cattle comprised 740 lbs. (+/−49 lbs.) and the average ending weight of the cattle comprised 943 lbs. (+/−58 lbs.), with an average daily rate of gain totaling 3.6 lbs./day.

### Example A: Grower Experiment—Experimental Diet Composition (n=12)

Demonstrated in FIG. 3, it may be observed that the inclusion of sprouted cercal grains in the experimental diets, grown according to the systems and methods of the present disclosure, produce a statistically significant (α=0.05) increase in soluble sugar concentrations in experimental diets as compared to the control. This statistically significant increase in soluble sugar concentrations provides the ability to elevate lactic acid producing bacteria in a viable and economic manner to reduce enteric carbon dioxide (CO₂) and methane (CH₄) emissions in ruminant livestock.

### Example B: Grower Experiment—NIR Digestibility Assessment (n=12)

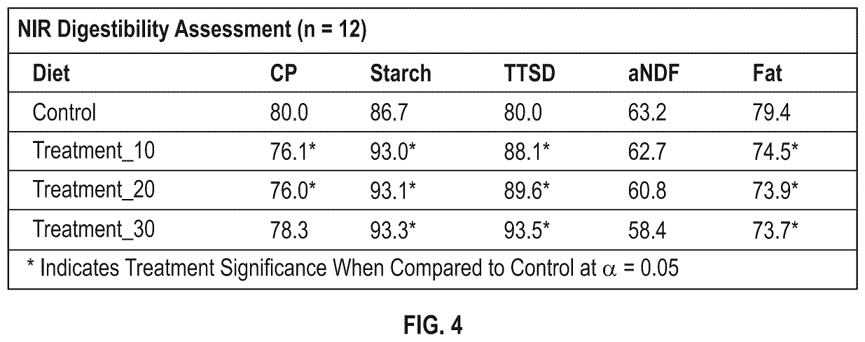

Demonstrated in FIG. 4, it may be observed that the inclusion of sprouted cereal grains in the experimental diets, grown according to the systems and methods of the present disclosure, produce a statistically significant (α=0.05) increase in starch digestion, including a statistically significant (α=0.05) reduction in fat digestion, in experimental diets as compared to the control. It is contemplated by the present disclosure that the statistically significant increase in starch digestion likely enables the increase in feed conversion efficiencies observed in ruminant livestock.

### Example C: Grower Experiment-Feedlot Performance Metrics

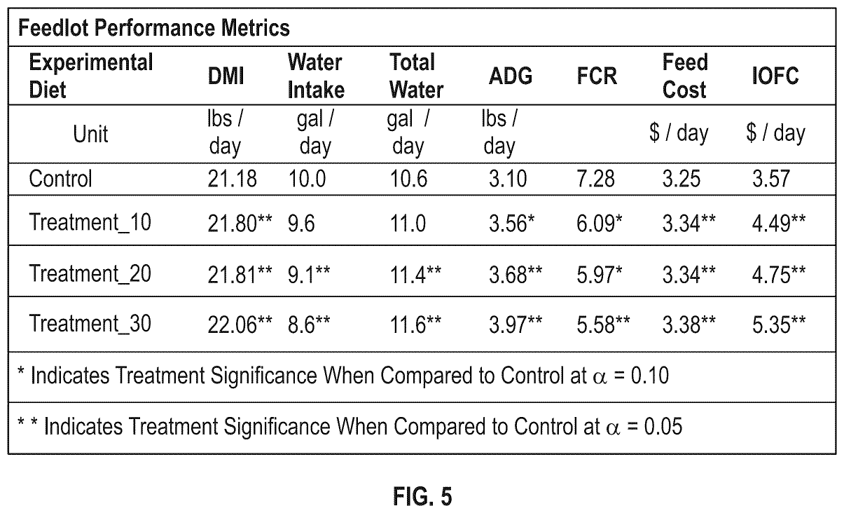

Demonstrated in FIG. 5, it may be observed that the inclusion of sprouted cereal grains in the experimental diets, grown according to the systems and methods of the present disclosure, produce a statistically significant (α=0.05) increase in feed consumption and water consumption on a daily basis in experimental diets as compared to the control. It is contemplated by the present disclosure that this statistically significant increase in feed conversion further results in a statistically significant increase in daily weight gain for the ruminant livestock. Because of the statistically significant increases in feed conversion and daily weight gain, improvements in daily income generated over feed cost (IOFC) are realized. For example, an increase of $0.92, $1.18, and $1.78 per animal per day were estimated for the 10%, 20% and 30% inclusion of sprouted cereal grains respectively, demonstrating the economic viability of the systems and methods of the present disclosure.

### Example D: Grower Experiment—Feedlot Performance Metrics

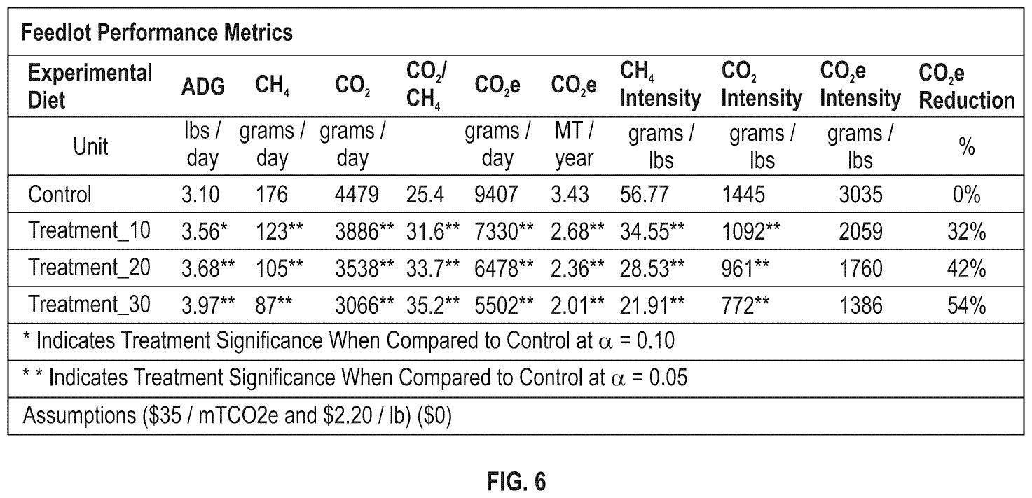

Demonstrated in FIG. 6, it may be observed that the inclusion of sprouted cereal grains in the experimental diets, grown according to the systems and methods of the present disclosure, produce a statistically significant (α=0.05) reduction in enteric carbon dioxide (CO₂) and methane (CH₄) emissions while at the same time increasing the average daily rate of gain in ruminant livestock. It is contemplated by the present disclosure that these combined effects significantly reduced the intensity of ruminant beef production by 32%, 42%, and 54% for the 10%, 20% and 30% inclusion of sprouted cereal grains, respectively, demonstrating the economic viability of the systems and methods of the present disclosure.

### Example E: Grower Experiment—In Situ Digestibility (RRL)

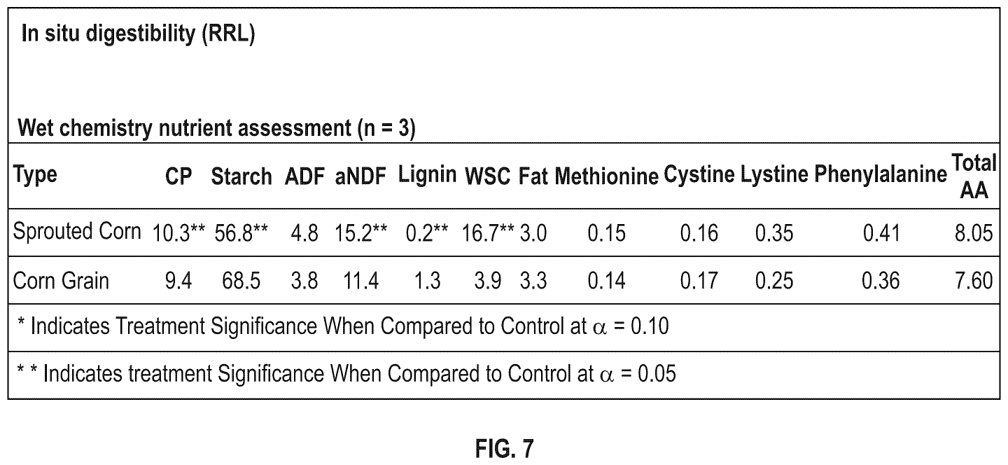

Demonstrated in FIG. 7, it may be observed that the inclusion of sprouted cereal grains in the experimental diets, grown according to the systems and methods of the present disclosure, produce a statistically significant (α=0.05) increase in crude protein (CP), fiber (aNDF), and soluble sugars (WSC) in combination with statistically significant reductions in starch and complex fibers (lignin).

### Example F: Grower Experiment—In Situ Digestibility (RRL)

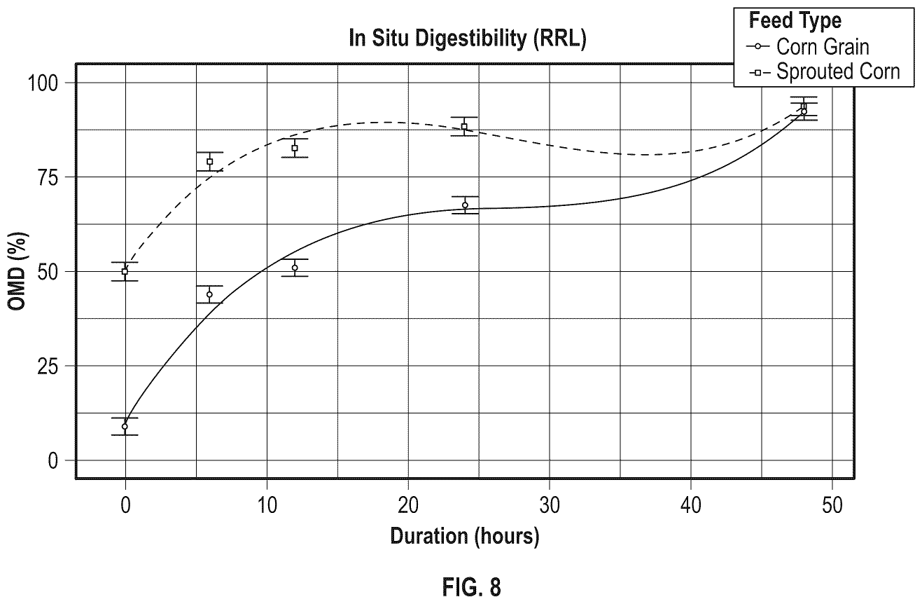

Demonstrated in FIG. 8, it may be observed that the inclusion of sprouted cereal grains in the experimental diets, grown according to the systems and methods of the present disclosure, produce a statistically significant (α=0.05) improvement in overall in situ digestibility for all sampling timepoints preceding forty-eight hours as compared to traditional mechanical processing techniques aimed at increasing digestibility in ruminant livestock.

### Example G: Grower Experiment—In Situ Digestibility (RRL)

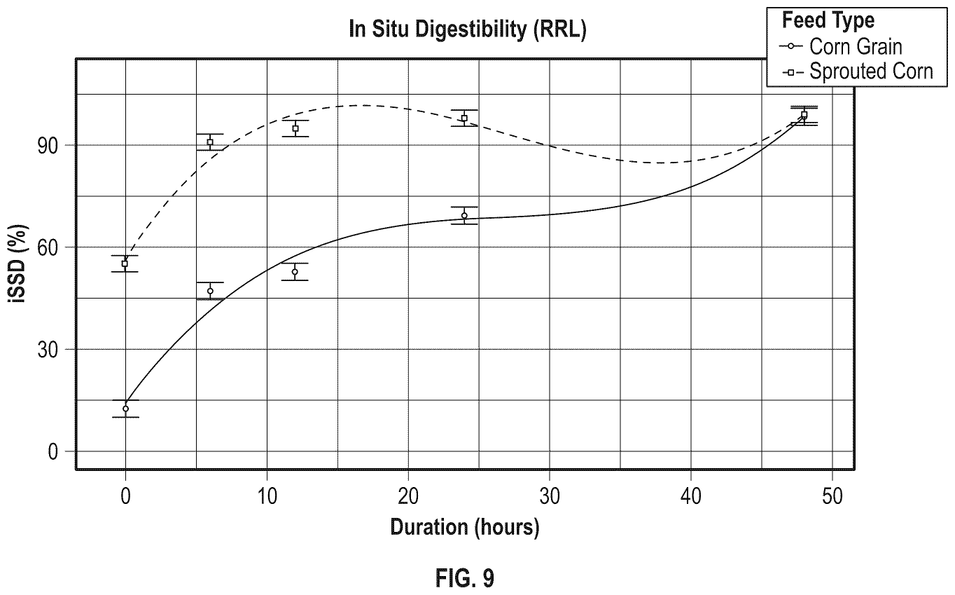

Demonstrated in FIG. 9, it may be observed that the inclusion of sprouted cereal grains in the experimental diets, grown according to the systems and methods of the present disclosure, produce a statistically significant (α=0.05) improvement in situ starch digestibility for all sampling timepoints preceding forty-eight hours as compared to traditional livestock feeds. It is contemplated by the present disclosure that such improvements highlight the intrinsic value of biological processing of sprouted cereal grains using the systems and methods disclosed herein as compared to traditional mechanical processing techniques aimed at increasing starch digestibility in ruminant livestock.

### Example H: Grower Experiment—Timepoint Analysis

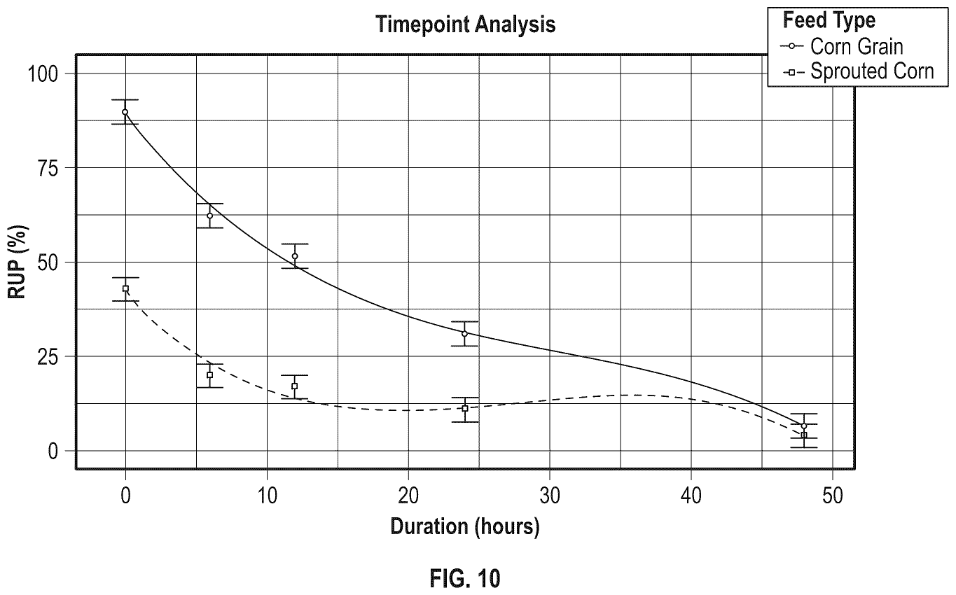

Demonstrated in FIG. 10, it may be observed that the inclusion of sprouted cereal grains in the experimental diets, grown according to the systems and methods of the present disclosure, produce a statistically significant (α=0.05) improvement in in situ protein digestibility for all sampling timepoints preceding forty-eight hours as compared to traditional livestock feeds. It is contemplated by the present disclosure that such improvements highlight the intrinsic value of biological processing of sprouted cereal grains using the systems and methods disclosed herein as compared to traditional mechanical processing techniques aimed at increasing starch digestibility in ruminant livestock.

The present disclosure is not to be limited to the particular aspects and examples described herein. In particular, the disclosure contemplates numerous variations in systems and methods of maximizing the value of sprouted grains as a feedstuff for ruminant livestock while reducing associated greenhouse gas emissions. The foregoing description has been presented for purposes of illustration and description. It is not intended to be an exhaustive list or limit any of the disclosure to the precise forms disclosed. It is contemplated that other alternatives or exemplary aspects are considered included in the invention. The description is merely examples of aspects, processes, or methods of the disclosure. It is understood that any other modifications, substitutions, and/or additions can be made, which are within the intended spirit and scope of the disclosure.

What is claimed is:

1: A method for maximizing the value of grains as a feedstuff for livestock, comprising:
forming a solution comprising water;
contacting the grains with the solution;
applying low volts of direct current to the grains and the solution for a first selected value;
reducing the pressure over the grains and the solution to a second selected value;
maintaining the low volts of direct current for a first chosen time period; and
maintaining the reduced pressure for a second chosen time period.

2: The method of claim 1, wherein the grains are chosen from barley, wheat, corn, sorghum, rice, oats, rye, and triticale, or mixtures thereof.

3: The method of claim 1, wherein the solution further comprises plant additives chosen from at least one nutrient, at least one fungicide, at least one insecticide, at least one signaling compound, at least one phytohormone, or combinations thereof.

4: The method of claim 3, wherein the at least one phytohormone comprises gibberellins, auxins, cytokinins, or combinations thereof.

5: The method of claim 1, wherein the solution further comprises at least one metallic salt.

6: The method of claim 5, wherein the at least one metallic salt comprises magnesium sulfate (MgSO₄), potassium nitrate (KNO₃), or combinations thereof.

7: The method of claim 5, wherein the at least one metallic salt comprises at least approximately 75 ppm of solution.

8: The method of claim 5, wherein the at least one metallic salt comprises a combination of magnesium sulfate (MgSO₄) at approximately 75.0 ppm and potassium nitrate (KNO₃) at approximately 150.0 ppm.

9: The method of claim 1, wherein the first selected value of low volts of direct current is less than or equal to approximately 36.0 volts of direct current, and the first chosen time period is at least approximately 120 minutes.

10: The method of claim 1, wherein the second selected value is a minimum reduced pressure of approximately 10.0 inches of mercury (Hg), and the second chosen time period is at least approximately 60 minutes.

11: The method of claim 1, further comprising the step of vibrating the vacuum chamber at a chosen vibrational frequency during said step of maintaining the reduced pressure for the second chosen period of time.

12: A method for maximizing the value of grains as a feedstuff for livestock, comprising:
providing a system for imbibing grains, the system comprising
a) a plurality of grains to be imbibed;
b) an aqueous solution for imbibing the grains, the solution comprising:
i. water;
ii. approximately 3.0-10.0 ppm of plant additives;
iii. approximately 40.0-60.0 ppm of a reactive oxygen species; and
iv. a minimum of 75 ppm of at least one metallic salt;
c) an electrode chamber configured to apply low volts of direct current;
d) a vacuum chamber configured to apply negative pressure;
e) a growing station for cultivating imbibed grains into plant seedlings; and
f) a mechanical processor for processing the plant seedlings into feedstuffs for livestock;
placing the solution into the electrode chamber and the vacuum chamber;
introducing the grains into the solution;
introducing a positively charged electrode of the electrode chamber into the solution with the grains;
connecting a negatively charged electrode of the electrode chamber to a grounding source;
applying low volts of direct current to the grains in the solution to a first selected value comprising less than or equal to approximately 36.0 volts of direct current;
maintaining the low volts of direct current for a first chosen time period comprising at least approximately 120 minutes;
reducing the pressure over the grains and the solution to a second selected value comprising approximately 10.0-25.0 inches of mercury (Hg);
maintaining the reduced pressure for a second chosen time period comprising approximately 60-240 minutes;
removing imbibed grains from the solution, the electrode chamber and the vacuum chamber;
introducing the imbibed grains into the growing station;
growing the grains in the growing station into plant seedlings;
harvesting the plant seedlings; and
processing the plant seedlings into feedstuff for livestock.

13: The method of claim 12, wherein the grains are chosen from barley, wheat, corn, sorghum, rice, oats, rye, and triticale, and mixtures thereof.

14: The method of claim 12, wherein the plant additives comprise phytohormones chosen from gibberellins, auxins, cytokinins, or combinations thereof.

15: The method of claim 12, wherein the reactive oxygen species comprises hydrogen peroxide (H₂O₂).

16: The method of claim 12, wherein the at least one metallic salt comprises magnesium sulfate (MgSO₄), potassium nitrate (KNO₃), or combinations thereof.

17: The method of claim 12, further comprising the step of vibrating the vacuum chamber at a chosen vibrational frequency during said step of maintaining the reduced pressure for the second chosen time period.

18: The method of claim 12, wherein a concentration of soluble sugars in ruminant diets is increased by approximately 8-24% as compared to traditional livestock feed.

19: A system for maximizing the value of grains as a feedstuff for livestock, the system comprising:
a plurality of grains to be imbibed;
an aqueous solution for imbibing the grains, the solution comprising:
a) water;
b) approximately 3.0-10.0 ppm of plant additives; and
c) a minimum of 75 ppm of at least one metallic salt;
an electrode chamber configured to apply low volts of direct current;
a vacuum chamber configured to apply negative pressure; and
a growing station for cultivating imbibed grains into plant seedlings.

20: The system of claim 19, further comprising a mechanical processor for processing the plant seedlings into feedstuffs for livestock.
